(19) United States
(12) Patent Application Publication
(10) Pub. No.: US 2003/0016380 A1
(43) Pub. Date: Jan. 23, 2003

(54) Printer

(76) Inventors: Masato Akitaya, Kanagawa (JP); Yumiko Yamaguchi, Kanagawa (JP)

Correspondence Address: PATENTS+TMS, A Professional Corporation, 1914 North Milwaukee Avenue, Chicago, IL, 60647, US

(21) Appl. No.: 10/201,104

(22) Filed: Jul. 23, 2002

(30) Foreign Application Priority Data
Jul. 23, 2001 (JP) 2001-222070

(51) Int. Cl. G06F 15/00; B41F 1/00

(52) U.S. Cl. 358/1.14; 358/1.16

(57) ABSTRACT

Disclosed is a printer that reproduces an image corresponding to the image data input from a source for supplying image data. The printer comprises an oscillator, a memory, a microcomputer, a gate IC, an LED driver, an LED head, a motor driver and a motor, a linear scale and a linear sensor, a heater driver and a heater, a sensor, and an EEPROM. When printing out the printer stores information on the state of the printer according to the status of printing in the EEPROM. If the power is turned on after the power has been turned off, the printer reads out the information stored in the EEPROM, and analyzes the information. If the printing paper is left in the printer, the printer delivers this printing paper.

### BACKGROUND OF THE INVENTION

1. Field of the Invention

The present invention relates to a printer.

2. Description of the Prior Art

A Cycolor® type printer is well known as one of printers using photosensitive printing papers. The Cycolor type printer reproduces (prints out) an image on the printing paper coated with photosensitive microcapsules (cyliths), which is so-called Cycolor medium (Cycolor type printing paper).

The Cycolor type printing paper is coated with many soft and photosensitive microcapsules that contain one of cyanic ink, magenta ink, and yellow ink. The microcapsules are placed on the paper at random, and they have the characteristics that microcapsules containing cyanic ink, magenta ink, or yellow ink are hardened in response to R (red) light, G (green) light, or B (blue) light, respectively. These colors have a relation of the complementary colors. Namely, when red light is emitted, cyanic capsules containing cyanic ink are hardened. Similarly, magenta capsules containing magenta ink are hardened when green light is emitted, and yellow capsules containing yellow ink are hardened when the blue light is emitted.

In the Cycolor type printer, the development is carried out by emitting light with color corresponding to an image data by means of a head for exposure, thereby exposing the printing paper, and then by mechanically pressuring the exposed printing paper. In the development step, the soft microcapsules that are not hardened are crushed, and one or more ink in the crushed microcapsules are mixed. Therefore, the printing paper is colored with the color corresponding to the image data, thereby the desired image is reproduced.

For example, if only red light is emitted on the printing paper, only cyanic capsules are hardened. Thus, in the development step, both soft magenta capsules and soft yellow capsules are crushed, and the printing paper is colored red by mixing the magenta ink and yellow ink.

If only green light is emitted on the printing paper, only magenta capsules are hardened. Thus, in the development step, both soft cyanic capsules and soft yellow capsules are crushed, and the printing paper is colored green by mixing the cyanic ink and yellow ink.

If only blue light is emitted on the printing paper, only yellow capsules are hardened. Thus, in the development step, both soft cyanic capsules and soft magenta capsules are crushed, and the printing paper is colored blue by mixing the cyanic ink and magenta ink.

The amount of hardened microcapsules with each color of RGB and the balance of each color can be changed by controlling both irradiation time of each color light and intensity of light (light exposure) of each color light. Therefore, the mixture condition of three-colors ink can be changed, thereby it is possible to represent a variety of neutral colors with this printer.

By the way, conventional printers use an LED head as the head for exposure. The LED head has three LEDs (e.g., red LED, green LED, and blue LED) that are aligned and mounted on the LED head.

In the exposure step, printing papers are placed close to and opposed to the LED head. A photosensitive printing paper is exposed by means of the LED head while the LED head is moved in a main scanning direction, and the printing paper is simultaneously moved in a sub scanning direction, which is substantially perpendicular to the main scanning direction. With this result, a latent image is recorded.

In the conventional printer, when the power to the printer is lost (turned off) as a result of power cut, battery shutoff, operator's failures, or the like during the printing, the printing paper is left in the printer. Therefore, if the printing paper left in the printer is not removed, it results in troubles in the operation of the printer.

For this reason, the printer has a plurality of sensors for detecting the presence of a printing paper. The sensors are arranged along the delivery direction of a printing paper in the printer. When the power is turned on, the sensors carry out the detection of a printing paper. If one or more sensors detect a printing paper, the printer is constructed so that the error message indicating that the printing paper remains inside the printer is displayed, or the printing paper is delivered automatically.

However, to detect the presence of a printing paper inside the printer, the printer must have many sensors. Therefore, it increases the number of components of the printer, and this results in increased manufacturing steps (assembling steps) for the printer. Further, it needs a lot of time for setup of the printer, and as a result the printer becomes costly.

### SUMMARY OF THE INVENTION

It is therefore an object of the present invention to provide a printer, which can operate properly without arranging many sensors even if the power to the printer is turned on after the power has been turned off during the printing

To accomplish the above-mentioned object, the present invention is directed to a printer for printing out a printing paper comprises: storage means for storing information on the condition of the printer corresponding to a status of printing operation; power supply means for supplying power to the printer; and readout means for reading out the information stored in the storage means when the power to the printer is turned on by the power supply means.

Here, the printer carries out printing operation based on the information read out from the storage means by the readout means when the power to the printer is turned on after the power has been turned off.

In one preferred embodiment, the storage means includes a rewritable nonvolatile memory.

Therefore, in spite of the condition of the printer just before the power is turned off, the printer of the present invention can operate properly without troubles.

For example, the printer of the present invention can deliver a printing paper, even if the power to the printer was turned off during the printing operation and the printing paper was left inside the printer.

Further, since the printer of the present invention can operate properly without arranging many sensors even if the power to the printer is turned on after the power has been turned off during the printing operation, the number of components can be reduced, the labor hour for manufacture (assembly of the printer) can be decreased and the time for assembling the printer can be shortened. Thus, the cost for the printer can be reduced.

The storage means may store information that the printer was on the way to print out a printing paper when the power to the printer was turned off during the printing operation.

The printer of the present invention may be constructed so as to deliver a printing paper if the information read out from the storage means by the readout means indicates that the printer was on the way to print out the printing paper.

Further, the printer may comprise a storage section for putting in printing papers. Here, the storage means may store any one of information that the printer began to pick up a printing paper from the storage section, information that the printer completed picking up the printing paper, and information that the printer completed printing out the printing paper.

The printer of the present invention may be constructed so as to deliver a printing paper if the information, which is read out from the storage means by the readout means when the power to the printer is turned on, indicates either that the printer began to pick up a printing paper or that the printer completed picking up the printing paper.

Here, the storage means may store information on the condition of the printer corresponding to a status of delivery operation when delivering a printing paper.

The printer of the present invention may be constructed so as to deliver the printing paper if the information read out from the storage means by the readout means indicates that the printer was on the way to deliver the printing paper.

Here, the storage means may store information on the condition of the printer corresponding to the number of fed lines of a printing paper when delivering a printing paper.

Similarly, the storage means may store information on the number of fed lines of a printing paper when printing out the printing paper.

Further, the printer of the present invention may comprise a head for exposure on which one or more light sources are provided. In this case, the printing paper is a photosensitive printing paper, and the printer may be constructed to reproduce an image on the photosensitive printing paper by exposing the photosensitive printing paper by means of the head for exposure.

In one preferred embodiment, the printer of the present invention may further comprise a head for exposure on which one or more light sources for emitting red light, one or more light sources for emitting green light, and one or more light sources for emitting blue light are provided. In this case, the printer may be constructed so as to reproduce an image on a photosensitive printing paper by exposing the photosensitive printing paper by means of the head for exposure.

Additionally, in another preferred embodiment, the printer may further comprise: a first group of registers for setting up the image data corresponding to the light sources for emitting red light, the image data corresponding to the light sources for emitting green light, and the image data corresponding to the light sources for emitting blue light; and a second group of registers for holding the image data, which is set up in the first group of registers.

In this case, the printer may be constructed to set next image data in the first group of registers and to drive each of the light sources provided on the head for exposure by using the image data that is held in the second group of registers in parallel.

The printer may be constructed so as to reproduce an image on a printing paper that contains a plurality of photosensitive microcapsules.

Similarly, the printer may be a Cycolor type printer.

### BRIEF DESCRIPTION OF THE DRAWINGS

FIG. 1 is a block diagram illustrating an embodiment of a printer according to the present invention.

FIG. 2 is a timing chart illustrating the relation between two encoded pulses FG1 and FG2 and an LR signal in the printer.

FIG. 3 is a bottom plan view illustrating an example of the structure of an LED head.

FIG. 4 is a block diagram illustrating an example of the structure of a principal part of a gate IC in the printer as shown in FIG. 1.

FIG. 5 is a timing chart illustrating the relation between the image data and an LED control signal in the printer as shown in FIG. 1.

FIG. 6 is a timing chart illustrating the operation when setting the image data to a first group of registers in the printer as shown in FIG. 1.

FIG. 7 is a timing chart illustrating the operation when holding the image data to a second group of registers in the printer as shown in FIG. 1.

FIG. 8 is a top view illustrating the condition where a printing paper is put in a storage section of the printer as shown in FIG. 1.

FIG. 9 is a top view illustrating the condition where a printing paper is picked up and set up at the initial position of the printer as shown in FIG. 1.

FIG. 10 is a top view illustrating the condition where a printing paper is fed until the number of printing line LN becomes the predetermined number of printing line X in the printer as shown in FIG. 1.

FIG. 11 is a top view illustrating the condition where a printing paper is fed until the paper feeding line number LN′ becomes the predetermined paper feeding line number Y in the printer as shown in FIG. 1.

FIG. 12 is a flowchart illustrating the control operation of a microcomputer when printing out.

FIG. 13 is a flowchart illustrating the control operation of a microcomputer when the power supply of the printer as shown in FIG. 1 turns on.

### DETAILED DESCRIPTION OF THE PREFERRED EMBODIMENTS

With reference to the appended drawings, a detailed description of the preferred embodiment of a printer according to the present invention will be given below.

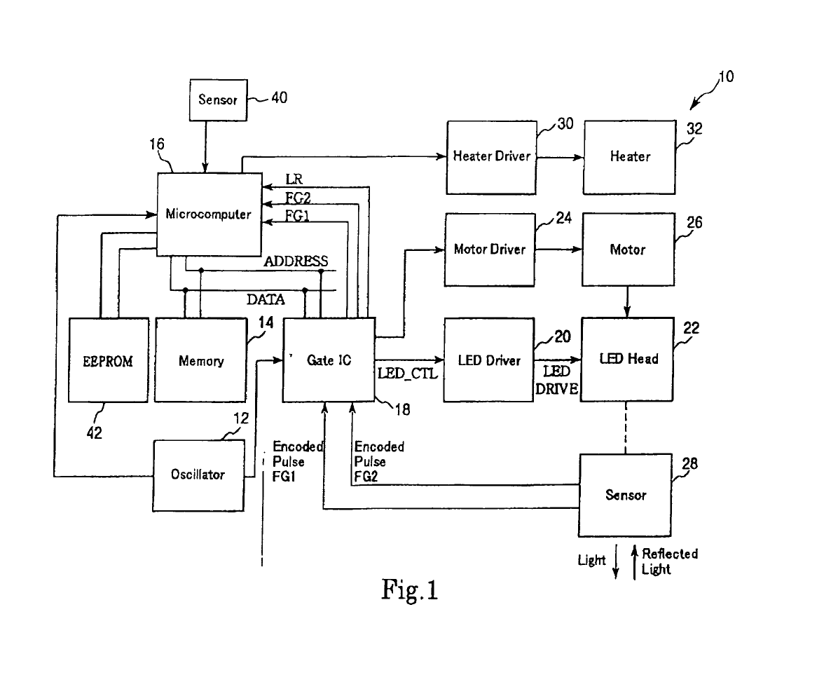

FIG. 1 is a block diagram illustrating an embodiment of a printer according to the present invention.

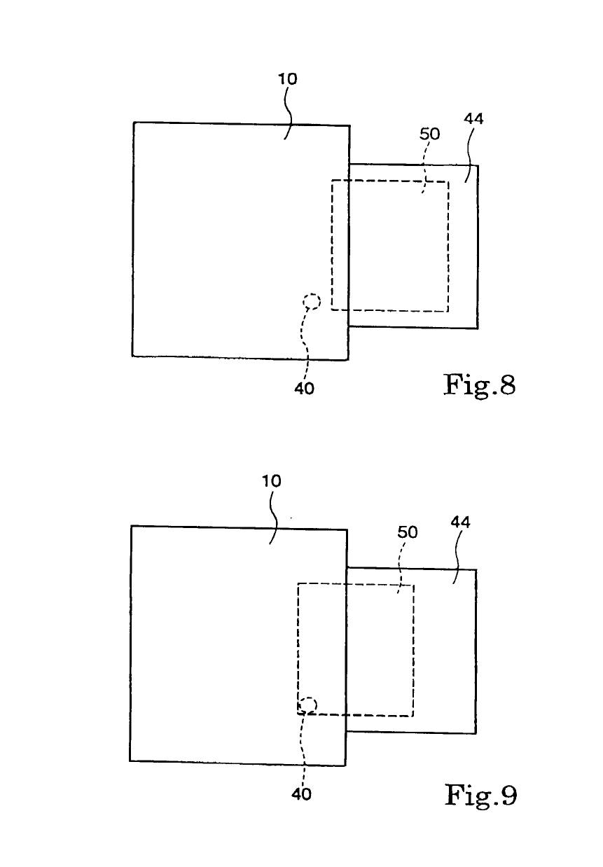

The printer 10 in FIG. 1 reproduces (prints) an image corresponding to the image data input from a source for supplying image data. As shown in FIG. 1, the printer 10 comprises an oscillator 12, a memory 14, an EEPROM (storage means) 42, a microcomputer 16, a gate IC (digital IC) 18, an LED driver 20, an LED head (optical head for exposing) 22, which is a head for the printer, a motor driver 24 and a motor 26, a linear encoder (not shown) that is composed of a linear scale and a linear sensor 28, a sensor for detecting mediums 40, a heater driver 30 and a heater 32, and a storage section 44 for putting printing papers therein (see FIG. 8).

Here, the image data is supplied from digital devices such as a personal computer (PC) and a digital camera, which handle image data as digital data, or analog devices such as a video player (VCR) and a television set (TV), which handle image data as the video signals that meet the standard such as NTSC and PAL.

The printer 10 is connected to the digital devices such as a PC via a parallel port, for example. The digital data transmitted from the digital devices via serial communication or the like is received at the printer 10 as image data. Also, the printer 10 is connected to the analog devices such as a VCR via a video terminal, for example. The video signals transmitted from the analog devices are received at the printer 10 as image data.

In addition, as mentioned above, the source of image data is not limited to either digital devices or analog devices. The devices that can transmit image data are utilizable as a source. Also, the connecting system between the printer 10 and the source and the type of image data are not limited thereto, for example, well-known interface standards and communication protocols and image data formatted with any type of format are utilizable.

Further, printing papers usable in the printer 10 are not limited, and various photosensitive type printing papers may be used. Printing papers such as printing papers coated with photosensitive microcapsules (cyliths) (Cycolor medium, Cycolor type printing paper), and Polaroid® film, both of which are known, are available.

In addition, the printer 10 comprises power supply circuits for supplying power at a given voltage to above-mentioned sections, an interface circuit between the printer 10 and the source of image data, a video decoder for decoding the video signals and converting image data to digital data, a pick-up mechanism of printing papers (initial feed mechanism), and a mechanism for feeding printing papers. These elements (components) are not shown in FIG. 1.

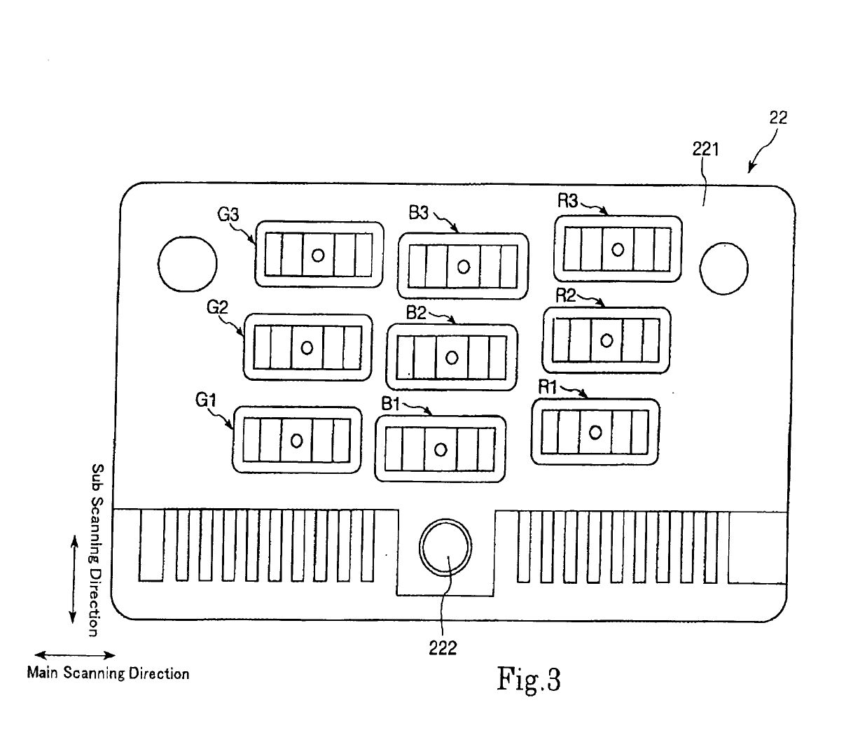

In the present embodiment, the printer 10 is the Cycolor type printer, which prints images onto printing papers coated with the photosensitive microcapsules (Cycolor mediums). The printer 10 comprises a pressure mechanism 222 for mechanically pressurizing the exposed printing paper to develop the image (developing process) (see FIG. 3). The pressure mechanism 222 may have a spherical surface or cylinder surface.

Hereinafter, each of the elements of the printer 10 will be described in turn.

In the printer 10 in FIG. 1, the oscillator 12 generates clock signals of the predetermined frequency. The clock signals generated in the oscillator 12 are supplied to almost all elements via the microcomputer 16 and the gate IC 18 These elements to which the clock signals are supplied operate in sync with the clock signals.

The memory 14 is a buffer (storage means) for storing the image data transmitted from the source of the image data. The memory 14 may be various types of known semiconductor memories. Examples of the semiconductor memories include various types of RAMs (Random Access Memory) such as SRAM (Static RAM) and DRAM (Dynamic RAM), and nonvolatile memories such as EPROM, EEPROM, and flash memory.

EEPROM (storage means) 42 is a rewritable nonvolatile memory for storing the information indicating the condition of the printer 10 corresponding progress of printing out (status of printing operation) and delivering (discharging) a printing paper (status of delivery operation (feeding operation)).

In the present invention, the storage means is not limited to the EEPROM 42. A flash memory may be used, for example.

The microcomputer 16 detects coordinate positions of a plurality of LEDs that are mounted on the LED head 22. In addition, the microcomputer 16 executes the control of communication of image data to the source, the control of the heater driver 30, the control of LED current (the control of light intensity), the control of the mechanical elements such as the pick-up mechanism of printing papers and the mechanism for feeding printing papers, and the detection of operation errors of these mechanisms.

The gate IC 18 controls the LED driver 20, the motor 26 via the motor driver 24, the memory 14, and so on.

The microcomputer16, the memory 14, and the gate IC 18 are connected via an address bus “ADDRESS” and a data bus “DATA” to each other. The image data stored in the memory 14 can be accessed via the address bus “ADDRESS” and the data bus “DATA” by both the microcomputer 16 and the gate IC 18.

The EEPROM 42 is the type that is used with a serial bus, and is connected to the microcomputer 16 via a dedicated serial bus. The microcomputer 16 can access to the data stored in the EEPROM 42 via the dedicated serial bus. The EEPROM 42 may be the type that is used with a parallel bus.

The image data supplied from the source is sent from microcomputer 16 to the memory 14 via the data bus “DATA,” and written (stored) to a given address specified in the memory 14.

When printing an image onto a printing paper, the microcomputer 16 reads out an image data stored in the memory 14, the image data and the address data corresponding to the image data are sent to the gate IC 18.

A control means for controlling the drive of the printer 10 includes the microcomputer 16 and the gate IC 18.

A sharing of the functions that the microcomputer 16 and the gate IC 18 execute in the present embodiment, is just an example, and may be modified if necessary.

The LED head 22 can expose printing papers. The LED head 22 comprises an LED (R-LED) emitting red light, an LED (G-LED) emitting green light, and an LED (B-LED) emitting blue light. The gate IC 18 controls the driving (for example, the emission timing) of these LEDs in the LED head 22 via the LED driver 20.

In the present invention, it is sufficient for the LED head 22 to have at least one LED for each of the colors, i.e., R-LED, G-LED and B-LED. However, the LED head 22 may have a plurality of LEDs for any one or two of the colors, or may have a plurality of LEDs for each of the colors. Providing a plurality of LEDs with the same color can speed up printing speed, and can prevent from lacking of light exposure even if an image is high-resolution printed out. In the present embodiment, the LED head 22 has three LEDs for each of the colors.

Here, the head for printer is not limited to the LED head 22 (i.e., the light source is not limited to LED), every head known in the art is available if it has a light source that emits light with the predetermined wavelength to expose a photosensitive printing paper (the head for exposure).

It should be noted that the head for printer that can be used in the present invention is not limited to the head for exposure as described above.

As shown in FIG. 8, a plurality of printing papers 50 are put in the storage section 44.

The motor 26 is driven by means of control of the gate IC 18 via the motor driver 24.

When printing operation is carried out, the motor 26 is driven, and the printing paper 50 is picked up from the storage section44 one by one by means of the pick-up mechanism (not shown) to be set at the initial position as shown in FIG. 9.

The LED head 22 reciprocates (moves) at a given constant speed in a main scanning direction by a head moving mechanism such as gears (not shown). The printing paper 50 is fed to a sub scanning direction which is substantially perpendicular to the main scanning direction by the mechanism for feeding printing papers (not shown). At this point, the printing paper 50 is exposed by the LED head 22, and a latent image corresponding to the image data is recorded (formed) on the printing paper 50.

The linear scale and the sensor 28 are utilized for detection of positions (coordinate positions) of the main and sub scanning directions of the LED head 22 with respect to the printing paper 50, i.e., for detection of each dot (pixel) while the LED head 22 reciprocates and for detection of direction of movement of the LED head 22 with respect to the printing paper 50.

The linear scale is a scale for an encoder with a plurality of monochrome bar-shaped printed patterns. The linear scale is provided at the predetermined position spaced apart from the LED head 22 so that the LED head 22 can be moved along the main scanning direction with respect to the linear scale. The patterns of the linear scale are placed in parallel with the predetermined constant interval (the predetermined pitch) along the direction of movement of the LED head 22 (the main scanning direction). In the present embodiment, the pitch of the patterns corresponds to the pitch of a pixel of an image.

On the other hand, the sensor 28 comprises an emitting section for emitting light toward the linear scale and a receiver section for receiving the light that is emitted from the emitting section and reflected from the linear scale (the received light then undergoes photoelectric-transferring).

The LED (light emitting diode) can be used as the emitting section. The photodiode or phototransistor can be used as the receiver section.

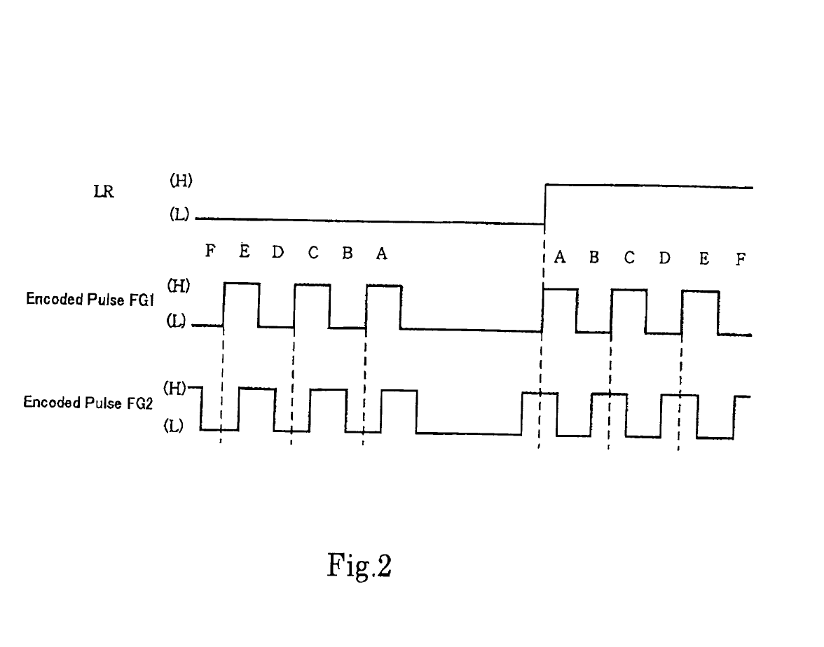

In the present embodiment, the LED head 22 and the sensor 28 are integrated on a carriage (not shown). As the carriage (i.e., the LED head 22) is moved, the sensor 28 outputs two encoded pulses FG1 and FG2, which have phases that shift by 90 degrees each other, as shown in the timing chart of FIG. 2 Both the encoded pulses FG1 and FG2 are delivered to the gate IC 18.

One cycle of the encoded pulse FG1 or FG2 (the period that the duration of high level (H) and the duration of low level (L) are added) corresponds to the time required for scanning (or moving over) the two dots of the image (i.e., twice of the pitch between the centers of adjacent two dots) in the main scanning direction.

When the LED head 22 moves toward one direction, the phase of the encoded pulse FG1 lags 90 degrees behind the phase of the encoded pulse FG2. When the LED head 22 moves toward the direction reverse the one direction, the phase of the encoded pulse FG1 leads 90 degrees against the phase of the encoded pulse FG2.

As shown in a timing chart of FIG. 2, the gate IC 18 latches a level of the encoded pulse FG2 at the rising point of the encoded pulse FG1 that is input from the sensor 28, and outputs an LR signal.

One cycle of the LR signal (the period that the duration of high level and the duration of low level are added) corresponds to the time for scanning (feeding) the dots for two lines of the image (i.e., twice of the pitch between the centers of adjacent two dots) in the sub scanning direction.

The direction of movement of the LED head 22 can be detected (distinguished) using the LR signal. Namely, when the LR signal's level is low, the direction of movement of the LED head 22 is the given direction (e.g., right hand of the LED head 22 as shown in FIG. 3). When the LR signal's level is high, the direction of movement is the reverse direction (e.g., left hand).

The duration that the levels of the encoded pulses FG1 and FG2 in FIG. 2 are low for a while, is a period when the LED 22 turns back (turnback period). The direction of movement of the LED head 22 is switched (reversed) in the turnback period.

The LR signal and the encoded pulses FG1 and FG2 mentioned above are sent to the microcomputer 16.

The microcomputer 16 detects the direction of movement of the LED head 22 and the position (coordinate position) in both main and sub scanning directions of the LED head 22 (i.e. the basis area of the LED head 22) based on the LR signal and the encoded pulses FG1 and FG2. Actually, the microcomputer 16 detects the direction of movement of the LED head 22 based on the LR signal and the encoded pulse FG2. Also, the microcomputer 16 sequentially detects (calculates) the coordinate positions of the plurality of LEDs mounted on the LED head 22 in the main and sub scanning directions by counting the number of pulses of the encoded pulse FG1 and the LR signal.

The microcomputer 16 also reads out the image data corresponding to the calculated coordinate positions of the plurality of LEDs from the memory 14 sequentially, and sends the image data and the address data indicating the LED corresponding to the image data to the gate IC 18 to set up the image data in a first group of registers mentioned hereinafter.

In this embodiment, the printer is constructed so that the microcomputer 16 calculates the coordinate positions of the plurality of LEDs to deal with the image data. However, the present invention is not limited thereto. For example, the printer may comprise a hard computing unit for calculating the coordinate positions and setting up the image data in the first group of registers.

Since the hard computing unit can calculate all the coordinate positions of the LEDs simultaneously in parallel operating as opposed to calculate the coordinate positions of the plurality of LEDs sequentially as the microcomputer 16 does, the printer with the hard computing unit has an advantage that the printer can calculate the coordinate positions at very high speed and in a short time. Therefore, since the microcomputer 16 is not required to have high working speed, inexpensive one with low working speed can be utilized, thereby being able to reduce the cost of the printer 10. Further, the printer with the hard computing unit is advantageous in that the LED head 22 is moved more quickly or the number of LEDs mounted on the LED head 22 is increased, for example, in order to shorten the printing time, or the resolution of the image is made to be higher.

The hard computing unit may be incorporated as a part of the gate IC 18, for example, and may be provided separately.

In the printer 10 as shown in FIG. 1, the heater 32 heats a printing paper after exposure and development to harden ink (image). The microcomputer 16 controls the operations of the heater 32 (e.g., timing of heating) via the heater driver 30.

The sensor 40 detects presence or absence of a printing paper 50. As shown in FIG. 8, the sensor 40 is installed in the side from which printing papers 50 are inserted into the printer 10. As shown in FIG. 8, the sensor 40 does not detect a printing paper 50 before the printing paper 50 is picked up by the pick-up mechanism of the printer 10. On the other hand, as shown in FIG. 9, the sensor 40 detects the presence of a printing paper 50 when a printing paper 50 is picked up to be set at the initial position. The sensor 40 and the pick-up mechanism are arranged for enabling to perform the above operations. Therefore, the printer 10 can detect that a printing paper 50 is picked up and set at the initial position as shown in FIG. 9, i.e., whether the pick-up of a printing paper 50 is completed. The detection signal from the sensor 40 is output to the microcomputer 16.

The sensor 40 comprises an emitting section for emitting light toward a printing paper 50 and a receiver section for receiving the light, which is emitted from the emitting section and reflected from the printing paper 50, (the received light then undergoes photoelectric-transferring).

The LED (light emitting diode) can be used as the emitting section. The photodiode or phototransistor can be used as the receiver section.

Next, the structure of the LED head 22 in the printer 10 will be described.

FIG. 3 is a bottom plan view illustrating an example of the structure of the LED head.

As shown in FIG. 3, the LED head 22 in the present embodiment has a head base 221, on which there are a total of nine LEDs (R1-R3, G1-G3, and B1-B3). The nine LEDs include three LEDs R1-R3 for emitting red light, three LEDs G1-G3 for emitting green light, and three LEDs B1-B3 for emitting blue light.

Here, as seen in FIG. 3, the nine LEDs are placed in the form of 3×3 matrix (tri-diagonal matrix), and they are arranged so as to be offset by a predetermined number of dots in the main and sub scanning directions each other

Namely, the LEDs R3, B3, and G3 are arranged in the top row of the matrix so that they are offset in this order by the predetermined number of dots in the up-down direction (the sub scanning direction) of FIG. 3. In the case of the structure as shown in FIG. 3, the LED G3 is placed at the center of the up-down direction in the top row, the LED R3 is placed at the upside of the position of the LED G3 by the predetermined dots, and the LED B3 is placed at the downside of the position of the LED G3 by the predetermined dots.

Further, LEDs R2, B2, and G2 are arranged in the middle row of the matrix so that they are offset in this order by the predetermined number of dots in the up-down direction of FIG. 3 in the same manner as the top row. Moreover, LEDs R1, B1, and G1 are also arranged in the bottom row of the matrix so that they are offset in this order by the predetermined number of dots in the up-down direction of FIG. 3 in the same manner as the top and middle rows.

Further, the LEDs R3, R2, and R1 are arranged in the right column of the matrix so that they are offset in this order by the predetermined number of dots in the left-right direction (the main scanning direction) of FIG. 3. In the case of the structure as shown in FIG. 3, the LED R2 is placed at the center of the left-right direction in the right column, the LED R1 is placed at the left side of the position of the LED R2 by the predetermined dots, and the LED R3 is placed at the right side of the position of the LED R2 by the predetermined dots.

Moreover, the LEDs B3, B2, and B1 are arranged in the middle column of the matrix so that they are offset in this order by the predetermined number of dots in the left-right direction of FIG. 3 in the same manner as the right column. Similarly, the LEDs G3, G2, and G1 are arranged in the left column of the matrix so that they are shifted in above-mentioned order by the predetermined number of dots in the left-right direction of FIG. 3 in the same manner as the middle and right columns.

As mentioned above, the printer 10 of the present embodiment causes the LED head 22 to move in the main scanning direction, and causes a printing paper to move in the sub scanning direction. In this case, the latent image is recorded on a photosensitive printing paper by sequentially emitting lights having the colors corresponding to an image data to the photosensitive printing paper by means of the nine LEDs R1-R3, G1-G3, and B1-B3 mounted on the LED head 22 and thereby two-dimensionally exposing the printing paper.

In other words, a latent image corresponding to an image data is recorded on each dot of a printing paper by sequentially emitting light from the LEDs R1-R3, G1-G3, and B1-B3 mounted on the LED head 22. In this regard, it is to be noted that the image data that is set up in each of the three LEDs R1-R3 is identical for each dot (the same image data is set up in each of the three LEDs R1-R3). Similarly, for each dot, the image data that is set up in each of the three LEDs G1-G3 is identical, and the image data that is set up in each of the three LEDs B1-B3 is identical.

Here, since each of all the LEDs is shifted in the sub scanning direction each other in the LED head 22 as shown in FIG. 3, for example, there is the time interval corresponding to more than a predetermined number of lines between the exposure of red light by means of the LED R3 and the exposure of green light by means of the LED G3. Also, there is the time interval corresponding to more than a predetermined number of lines between the exposure of green light by means of the LED G3 and the exposure of blue light by means of the LED B3.

In the printing paper coated with photosensitive microcapsules, there is a property that the sensibility of the microcapsule is increased by emitting light at regular intervals rather than emitting light continuously. Therefore, there is an advantage that the sensibility of the printing paper can be enhanced by shifting the positions of each LED in the sub scanning direction as the LED head 22 as shown in FIG. 3.

In this regard, it is to be noted that the arrangement of each LED (e.g., its spacing or its shift length) is not limited thereto, and it may be modified properly if necessary.

The pressure mechanism 222 for mechanically pressurizing the exposed printing paper to develop the image (developing process) is mounted on the head base 221. The pressure mechanism 222 is placed at the lower side of the head base 221 in FIG. 3.

Next, the internal structure of the gate IC 18 in the printer 10 will be described.

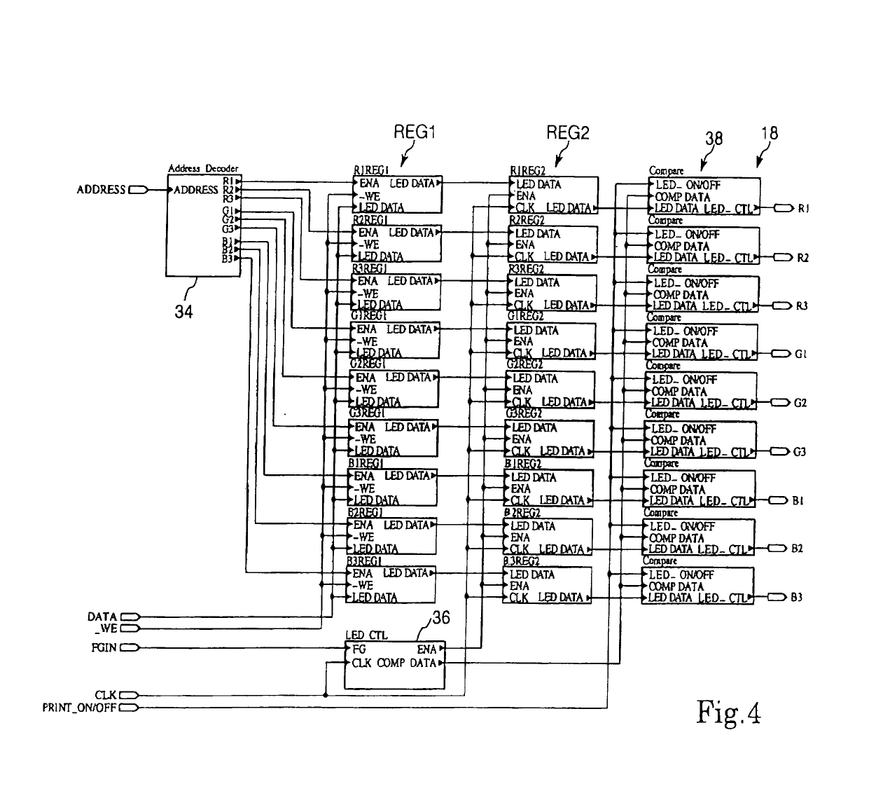

FIG. 4 is a block diagram illustrating an example of the structure of a principal part of the gate IC 18 in the printer 10 as shown in FIG. 1.

The parts to control the LED driver 20 within the gate IC 18 are shown in FIG. 4. As shown in FIG. 4, the gate IC 18 comprises an address decoder 34, an LED control circuit 36, a first group of registers REG1, a second group of registers REG2, and a group of comparators 38. In addition, components of the gate IC 18 other than those described above are omitted to simplify the following explanation.

The microcomputer 16 inputs image data “LED DATA” to the first group of registers REG1 via a data bus “DATA.” The microcomputer 16 also inputs the address signal that specifies the LED (i.e., a first register) corresponding to the image data “LED DATA” to the address decoder 34 via an address bus “ADDRESS.”

The address decoder 34 decodes the address signal input from the microcomputer 16 via the address bus “ADDRESS,” and outputs an enable signal “ENA” to designate (select) a first register corresponding to the address signal in the first group of registers REG1.

The register designated by the “ENA” fetches and latches “LED DATA” that is output to the data bus “DATA” at this point.

The LED control circuit 36 generates the enable signal “ENA” and comparative data “COMP DATA” based on either the encoded pulse FG1 or FG2, which are input from the sensor 28 (hereinafter, referred to as an encoded pulse “FG”), and outputs them to the second group of registers REG2 and the group of comparators 38 respectively.

The enable signal “ENA” output from the LED control circuit 36 is a timing signal to hold the image data “LED DATA” set up in and transferred from the first group of registers REG1 to the second group of registers REG2 in parallel. It is output at a predetermined timing after the exposure of nine dots in the position of the just preceding dot is completed.

Further, the comparative data “COMP DATA” is utilized to decide the times when the nine LED R1-R3, G1-G3, and B1-B3 are made to emit light by comparing the comparative data “COMP DATA” with the image data “LED DATA” held in the second group of registers REG2. The comparative data “COMP DATA” is generated by counting a clock signal “CLK,” and output to the group of comparators 38 in synchronization with the encoded pulse “FG.”

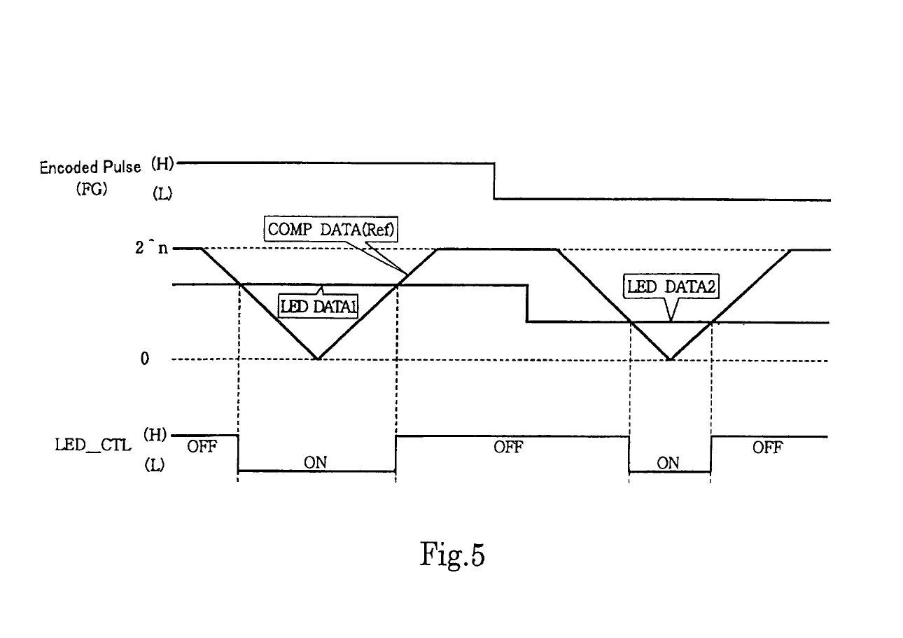

For example, as shown in the timing chart of FIG. 5, an n-bit counter is used to generate the comparative data “COMP DATA.” The counter is synchronized with the encoded pulse “FG” and repeats to count down from (2ˆ n)−1 to 0 and then to count up from 0 to (2ˆ n)−1. The down/up operation of the counter is shown by the waveform like a triangular wave in the timing chart of FIG. 5. Here, n is 8 in this embodiment, but it should be noted that n is not limited to 8.

In addition, as mentioned above, since one cycle of the encoded pulse “FG” corresponds to the time required for moving over two dots of the image in the main scanning direction, the above-mentioned operation of the counter is executed for both the duration when the level of the encoded pulse “FG” is high and the duration when the level of the encoded pulse “FG” is low.

The first group of registers REG1 and the second group of registers REG2 comprise the same number of registers as the number of LEDs mounted on the LED head 22 respectively. The group of comparators 38 comprises the same number of comparators as the number of LEDs mounted on the LED head 22. In the present embodiment, since the total of nine LEDs are mounted on the LED head 22, the first group of registers REG1 comprises nine first registers, and the second group of registers REG2 comprises nine second registers. Also, the group of comparators 38 comprises nine comparators “Compare.”

The first group of registers REG1 is used to set up the image data “LED DATA” corresponding to each of the LEDs R1-R3, G1-G3, and B1-B3 that are mounted on the LED head 22. The image data “LED DATA” is sent from the microcomputer 16 via the data bus “DATA.”

The first group of registers REG1 comprises nine first registers as mentioned above. In FIG. 4, they include the first registers R1REG1, R2REG1, and R3REG1 to hold the image data “LED DATA” corresponding to three LEDs for red light R1, R2, and R3, the first registers G1REG1, G2REG1, and G3REG1 to hold the image data “LED DATA” corresponding to three LEDs for green light G1, G2, and G3, and the first registers B1REG1, B2REG1, and B3REG1 to hold the image data “LED DATA” corresponding to three LEDs for blue light B1, B2, and B3.

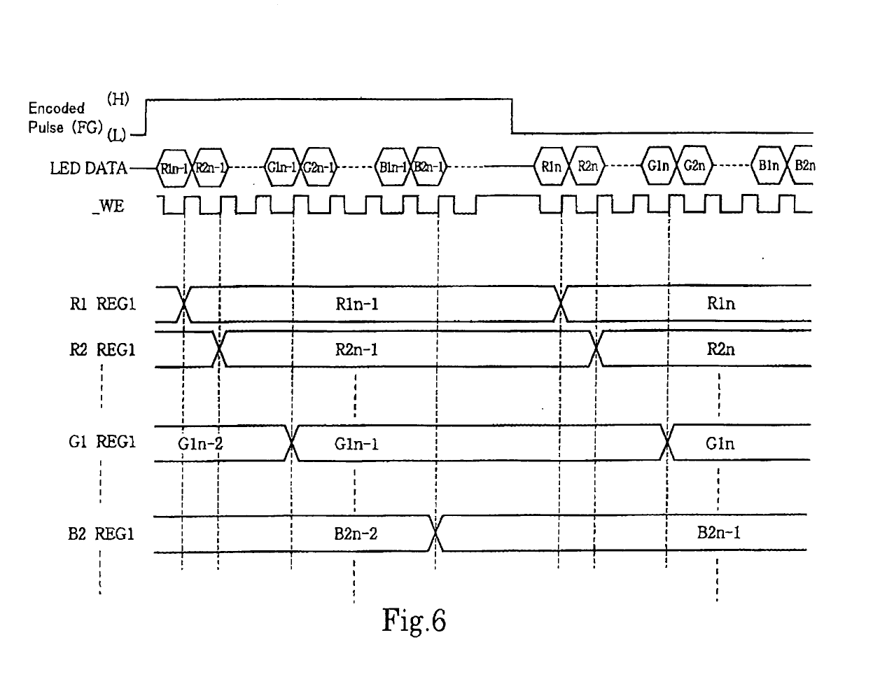

In the first group of registers REG1, as shown the timing chart of FIG. 6, the image data “LED DATA” corresponding to nine LEDs R1-R3, G1-G3, and B1-B3 is sequentially set up in the first register selected by the enable signal “ENA” in synchronization with the encoded pulse “FG” and the rising edge of a write enable signal “_WE” input from the microcomputer 16.

In this way, the image data “LED DATA” corresponding to the total of nine LEDs R1-R3, G1-G3, and B1-B3 on the LED head 22 is set up in the first registers R1REG1-R3REG1, G1REG1-G3REG1, and B1REG1-B3REG1 sequentially by means of the microcomputer 16.

In addition, as mentioned above, since one cycle of the encoded pulse “FG” corresponds to the time required for moving over two dots of the image in the main scanning direction, the setup of the image data from the microcomputer 16 to the first group of registers REG1 is executed for both the duration when the level of the encoded pulse “FG” is high and the duration when the level of the encoded pulse “FG” is low.

On the other hand, the second group of registers REG2 is used to hold the image data “LED DATA” corresponding to each of the nine LEDs R1-R3, G1-G3, and B1-B3 in parallel, which have been sequentially set up in the first group of registers REG1.

The second group of registers REG2 comprises nine second registers as mentioned above. In FIG. 4, they include the second registers R1REG2, R2REG2, and R3REG2 to hold the image data “LED DATA” corresponding to three LEDs for red light R1, R2, and R3, the second registers G1REG2, G2REG2, and G3REG2 to hold the image data “LED DATA” corresponding to three LEDs for green light G1, G2, and G3, and the second registers B1REG2, B2REG2, and B3REG2 to hold the image data “LED DATA” corresponding to three LEDs for blue light B1, B2, and B3.

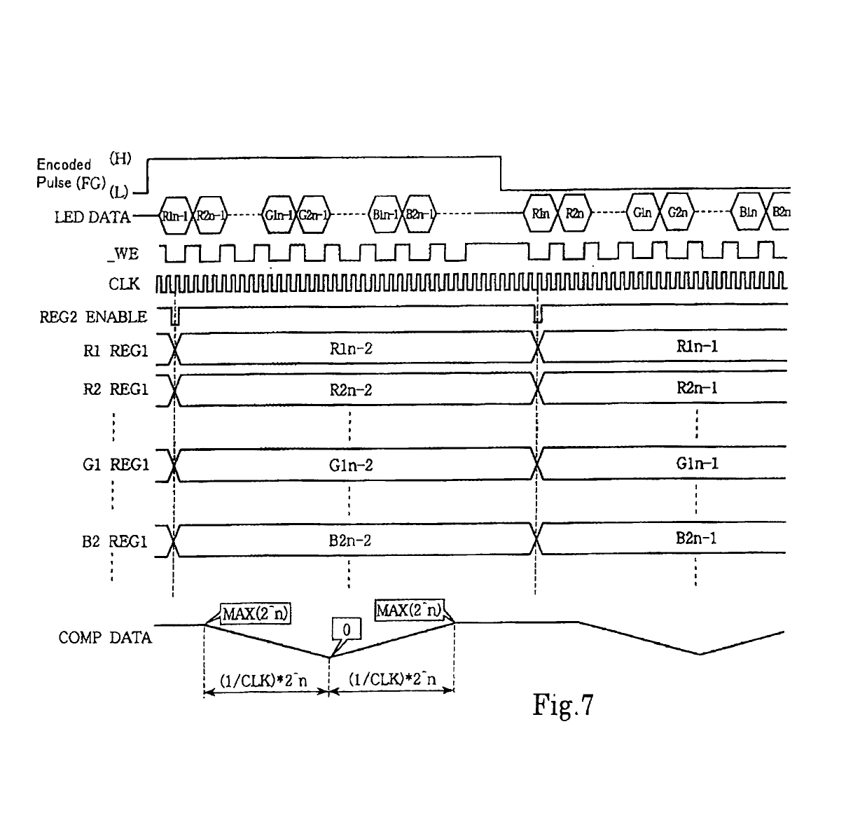

In the second group of registers REG2, as shown the timing chart of FIG. 7, the image data “LED DATA” corresponding to nine LEDs R1-R3, G1-G3, and B1-B3, which are set up in the first group of registers REG1, is held (shifted) in parallel by being synchronized with the encoded pulse “FG,” and being synchronized with the rising edge of a clock signal “CLK” sent from the oscillator 12 while the level of the enable signal “ENA” is low.

Namely, the image data “LED DATA” corresponding to the total of nine LEDs R1-R3, G1-G3, and B1-B3, which are set up in the first group of registers R1REG1-R3REG1, G1REG1-G3REG1, and B1REG1-B3REG1, is held in the second group of registers R1REG2-R3REG2, G1REG2-G3REG2, and B1REG2-B3REG2 in parallel.

As mentioned above, since one cycle of the encoded pulse “FG” corresponds to the time required for moving over two dots of the image in the main scanning direction, the transfer (shift) of the image data from the first group of registers REG1 to the second group of registers REG2 is executed for both the duration when the level of the encoded pulse “FG” is high and the duration when the level of the encoded pulse “FG” is low.

As seen in the timing charts in FIGS. 6 and 7, the setup of the image data from the microcomputer 16 to the first group of registers REG1 is executed in parallel with the holding of the image data in the second group of registers REG2 and the emission of the LEDs (the exposure to a printing paper).

Concretely, the image data for the (n−2)^{th} exposure is held in the second group of registers REG2. The image data for the (n−1)^{th} exposure is set up in the first group of registers REG1 by the microcomputer 16 while the (n−2)^{th} exposure is executed based on the image data for the (n−2)^{th} exposure.

After the setup of the image data and the exposure are completed, the image data set up in the first group of registers REG1 is transferred to the second group of registers REG2, and held in the second group of registers REG2.

The (n−1)^{th} exposure and the setup of the image data for the n^{th} exposure to the first group of registers REG1 by means of the microcomputer 16 are then executed.

Subsequently, the operations mentioned above are repeated.

In this way, since the printer 10 comprises the second group of registers REG2, the data held in the first group of registers REG1 can be held in the second group of registers REG2 at the transition point of the encoded pulse “FG.” Therefore, since the image data held in the second group of registers REG2 is used for the drive of LEDs, the microcomputer 16 can set up the next image data to the first group of registers REG1 after the detection of the transition point of the encoded pulse “FG.”

Namely, since the printer 10 has the structure in which the first group of registers REG1 for the setup of the image data and the second group of registers REG2 for the drive of the LEDs are separated, it is sufficient for the printer 10 to have only the function to set up the next image data while exposing one dot (during one exposure). Therefore, even if an inexpensive microcomputer with low working speed is used as the microcomputer 16, a plurality of image data to be set up in the LED head 22 can be set up surely with reasonable storage capacity. Thus, the printer 10 can deal with the demand of the speed-up of the printing speed, i.e., shortening of the printing time or high resolution (high definition) of an image more easily.

Each comparator “Compare” of the group of comparators 38 outputs an LED control signal “LED CTL” for controlling an LED driver 20 to the LED driver 20.

In this case, to each comparator of the group of comparators 38, a printing on/off signal “PRINT_ON/OFF” to switch between the printing state and the non-printing state is input from the microcomputer 16, the image data “LED DATA” is input from a corresponding second register in the second group of registers REG2, and the comparative data “COMP DATA” is input from the LED control circuit 36. Each comparator “Compare” compares the image data “LED DATA” held in the second group of registers REG2 with the comparative data “COMP DATA” input from the LED control circuit 36, and outputs an LED control signal for controlling the LED driver 20 based on the comparative result and the printing on/off signal “PRINT_ON/OFF” input from the microcomputer 16.

As shown in the timing chart of FIG. 5, the LED control signal “LED CTL” becomes low level while the level of the image data “LED DATA” is higher than that of the comparative data “COMP DATA” and further while the level of the printing on/off signal “PRINT_ON/OFF” is low, which indicates that the printer 10 is in the printing state. The LEDs emit lights while the level of the LED control signal “LED CTL” is low.

In addition, the polarity of the LED control signal “LED CTL” is not limited to either low or high. It should be noted that the LEDs could emit lights while the polarity of the LED control signal “LED CTL” is high level reversely.

In the Cycolor type printer 10 of the present embodiment, printing papers 50 are placed close to and opposed to the LED head 22. The printer 10 exposes a photosensitive printing paper by moving the LED head 22 in the main scanning direction, and simultaneously emitting lights with colors corresponding to the image data. When the LED head 22 arrive at one end of the printing region, the photosensitive printing paper 50 is moved by a predetermined number of dots in the sub scanning direction, and similarly the printer 10 moves the LED head 22 in the main scanning direction and emits lights with colors corresponding to the image data to the photosensitive printing paper 50. Subsequently, the operations mentioned above are repeated.

Thus, the photosensitive printing paper 50 is two-dimensionally exposed by means of the LED head 22, thereby the latent image being recorded on the photosensitive printing paper 50.

In this exposure step, the linear scale and the sensor 28 generate the encoded pulses FG1 and FG2 as the LED head 22 is moving. The LR signal is generated from the encoded pulses FG1 and FG2 in the gate IC 18. The microcomputer 16 calculates coordinate positions of nine LEDs R1-R3, G1-G3, and B1-B3 that are provided (mounted) on the LED head 22, reads out the image data corresponding to each of the LEDs R1-R3, G1-G3, and B1-B3 from the memory 14, and sets up the image data read out from the memory 14 in the first group of registers REG1 in the gate IC 18 sequentially.

In the development step, the portion in the printing paper 50 where the exposure is completed is mechanically pressured by being interposed between the pressure mechanism 222 and a pressed surface (not shown), thereby developing the image data. Therefore, the image data is developed on the whole of the printing paper 50 by moving the LED head 22 in the main scanning direction and moving the printing paper 50 in the sub scanning direction.

In the development step, microcapsules that are not hardened to be left soft are crushed by the pressure mechanism 222 and the pressed surface, the ink in the crushed microcapsules is mixed each other, and the printing paper 50 is colored in accordance with the image data, thereby a desired image being reproduced on the printing paper 50.

Then, the developed printing paper 50 is heated by means of the heater 32, thereby hardening the image on the printing paper 50. At this point, the printing processing is completed.

The printer 10 mentioned above stores information on the states of the printer 10 according to the status of printing and delivery of a printing paper in the EEPROM 42 when printing out and delivering the printing paper. When the power to the printer 10 is turned on after the power has been turned off, the printer 10 reads out the information stored in the EEPROM 42, and operates based on the information.

Namely, if the power to the printer 10 is turned off while printing, the information indicating the condition on the way to print out a printing paper is stored in the EEPROM 42. Also, if the power to the printer 10 is turned off while delivering a printing paper, the information indicating the condition on the way to deliver a printing paper is stored in the EEPROM 42. When the power is turned on after the power has been turned off, the printer 10 reads out the information stored in the EEPROM 42. If the information indicates the condition on the way to print out a printing paper or the condition on the way to deliver a printing paper, the printer 10 delivers the printing paper.

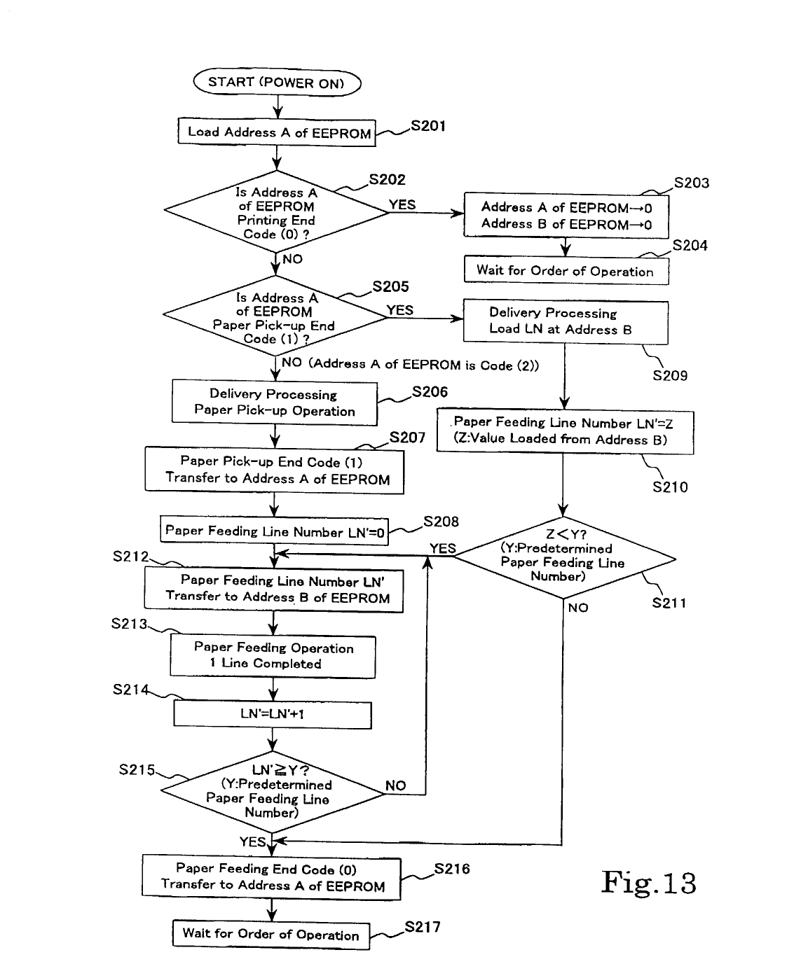

Hereinafter, the operation of the printer of the present invention will be described based on flowcharts as shown in FIGS. 12 and 13.

FIG. 12 is a flowchart illustrating the control operation of the microcomputer when printing out a printing paper. FIG. 13 is a flowchart illustrating the control operation of the microcomputer when the power supply of the printer as shown in FIG. 1 turns on.

As shown in FIG. 12, when printing out, “Paper Pick-up Start Code (2),” which indicates the start of pick-up of a printing paper 50, is transferred to Address A in the EEPROM 42, and is stored therein (Step S101).

Next, the pick-up operation of the printing paper 50 is carried out (Step S102).

In this way, as shown in FIG. 9, the printing paper 50 is picked up from the storage section 44 to be set at an initial position for printing out.

If the power has been turned off during the pick-up operation, “Paper Pick-up Start Code (2)” is stored in Address A in the EEPROM 42. Therefore, when the power is turned on later, the printer 10 can recognize that the power was turned off during the pick-up operation.

After the pick-up operation of the printing paper 50 is completed, “Paper Pick-up End Code (1),” which indicates the end of pick-up of a printing paper 50, is transferred to Address A in the EEPROM 42, and is stored therein (Step S103). Thus, the information stored in Address A in the EEPROM 42 is overwritten with “Paper Pick-up End Code (1).”

A printing line number (linage) LN, which indicates the number of delivered lines of the printing paper 50 (the line number from the initial position), is reset to “0” (LN=0) (Step S104).

The printing line number LN is transferred to Address B in the EEPROM 42, and stored therein (Step S105).

The printer 10 starts a printing operation. The printer 10 exposes (prints) one line of the printing paper 50 by moving the LED head 22 in the main scanning direction (Step S106).

The printing line number LN is incremented by one (LN=LN+1) (Step S107).

Then, determination is made as to whether the printing line number LN becomes a predetermined number of printing line X (LN=X), i.e., whether the printing operation is completed (Step S108).

If it is determined that the printing line number LN does not become the predetermined number of printing line X (LN<X) in Step S108, i.e., if the printing operation is not completed, then the printer 10 returns to Step S105, and again executes the same processing from Step S105.

If the power is turned off after the pick-up operation of the printing paper is completed and before the printing operation is completed, then “Paper Pick-up End Code (1)” is stored in Address A in the EEPROM 42, and the printing line number LN is stored in Address B in the EEPROM 42. Therefore, when the power is turned on, the printer 10 can recognize that the power was turned off after the pick-up operation of the printing paper has been completed and before the printing operation has been completed. Further, the printer 10 can also recognize the value of the printing line number LN.

On the other hand, if it is determined that the printing line number LN becomes the predetermined number of printing line X (LN=X) in Step S108, i.e., if the printing operation is completed, then “Printing End Code (0),” which indicates that the printing operation is completed, is transferred to Address A in the EEPROM 42, and is stored therein (Step S109). Thus, the information stored in Address A in the EEPROM 42 is overwritten with “Printing End Code (0).”

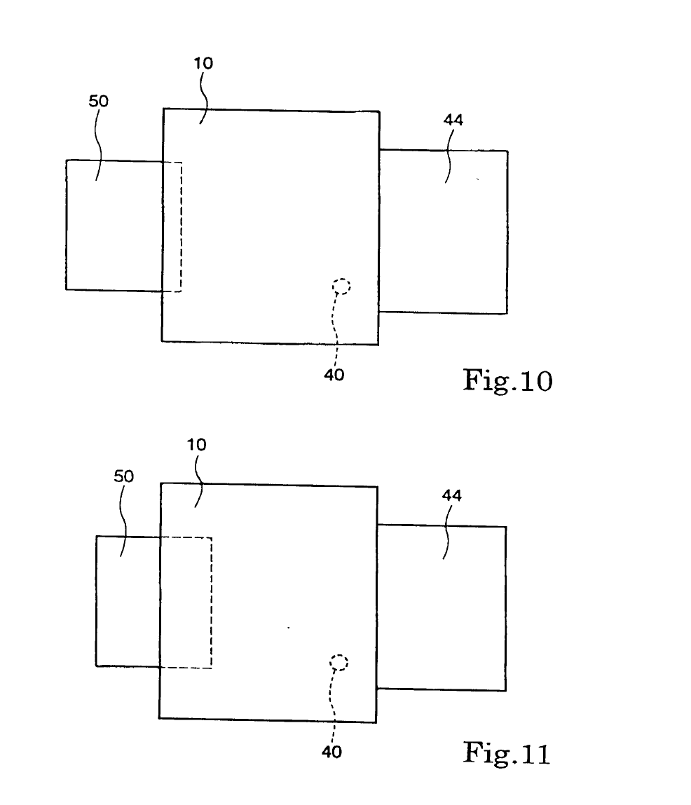

As shown in FIG. 10, when the printing line number LN becomes the predetermined printing line number X, so the printing operation is completed, then the printing paper 50 is held under the condition that it is partially protruded from a delivery mouth of the printer 10. The user takes the printing paper 50, and gets it out to remove the printing paper 50 from the printer 10.

At this point, the printer 10 terminates this program.

Next, when the power is turned on after the power has been turned off, the program as shown in FIG. 13 is executed.

As shown in FIG. 13, when the power is turned on, the printer 10 reads out the information from the Address A in the EEPROM 42 (Step S201).

Then, determination is made as to whether the information read out from Address A in the EEPROM 42 is “Printing End Code (0)” or “Paper Feeding End Code (0)” mentioned later (Step S202). If “0” is stored at Address A in the EEPROM 42, the value indicates “Printing End Code” or “Paper Feeding End Code.” Both codes are not distinguished.

If it is determined that the information is “Printing End Code (0)” in Step S202, i.e., if the power is turned off after printing operation has been completed or delivery operation has been completed, then the printer 10 resets Addresses A and B to “0” (Step S203), and waits for a next operation order (Step S204). The printer 10 proceeds to the next operation after the receipt of the operation order.

On the other hand, if it is determined that the information is not “Printing End Code (0)” or “Paper Feeding End Code (0)” in Step S202, it is determined whether the information read from Address A in the EEPROM 42 is “Paper Pick-up End Code (1)” (Step S205).

If it is determined that the information is not “Paper Pick-up End Code (1)” in Step S205, i.e., if the power was turned off during the pick-up operation of the printing paper 50, then the printer 10 proceeds to the delivery operation, and executes the pick-up operation of the printing paper 50 (Step S206).

After the pick-up operation of the printing paper 50 is completed, “Paper Pick-up End Code (1),” which indicates the end of pick-up of a printing paper 50, is transferred to Address A in the EEPROM 42, and is stored therein (Step S207). Thus, the information stored in Address A in the EEPROM 42 is overwritten with “Paper Pick-up End Code (1).”

A paper feeding line number LN′, which indicates the number of fed lines of the printing paper 50 (the line number from the initial position), is reset to “0” (LN′=0) (Step S208).

The paper feeding line number LN′is transferred to Address B in the EEPROM 42, and stored therein (Step S212).

The printer 10 starts a feeding operation, and moves a printing paper 50 by one dot in the sub scanning direction, i.e., the printer 10 feeds the printing paper 50 by one line (Step S213).

The paper feeding line number LN′is incremented by one (LN′=LN′+1) (Step S214).

Then, determination is made as to whether the paper feeding line number LN′ becomes more than a predetermined paper feeding line number Y (LN′>=Y), i.e., whether the printing paper 50 is fed to a predetermined position for delivery end or more (Step S215).

If it is determined that the paper feeding line number LN′ does not become the predetermined paper feeding line number Y (LN′<Y) in Step S215, i.e., if the printing paper 50 is fed only before the predetermined position, then the printer 10 returns to Step S212, and again executes the same processing from Step S212.

If the power was turned off after the pick-up operation of the printing paper has been completed and before the feeding operation has been completed, then “Paper Pick-up End Code (1)” is stored in Address A in the EEPROM 42, and the paper feeding line number LN′ is stored in Address B in the EEPROM 42. Therefore, when the power is turned on, the printer 10 can recognize that the power was turned off after the pick-up operation of the printing paper has been completed and before the feeding operation has been completed. Further, the printer 10 can also recognize the value of the paper feeding line number LN′.

On the other hand, if it is determined that the paper feeding line number LN′ becomes sore than the predetermined paper feeding line number Y (LN′>=Y) in Step S215, i.e., if the printing paper 50 is fed to the predetermined position for delivery end or more, then “Paper Feeding End Code (0),” which indicates that the feeding operation (delivery operation) is completed, is transferred to Address A in the EEPROM 42, and is stored therein (Step S216). Thus, the information stored in Address A in the EEPROM 42 is overwritten with “Paper Feeding End Code (0).”

When the delivery operation is completed at Step S216, the printer 10 waits for a next operation order (Step S217). The printer 10 proceeds to the next operation after the receipt of the operation order.

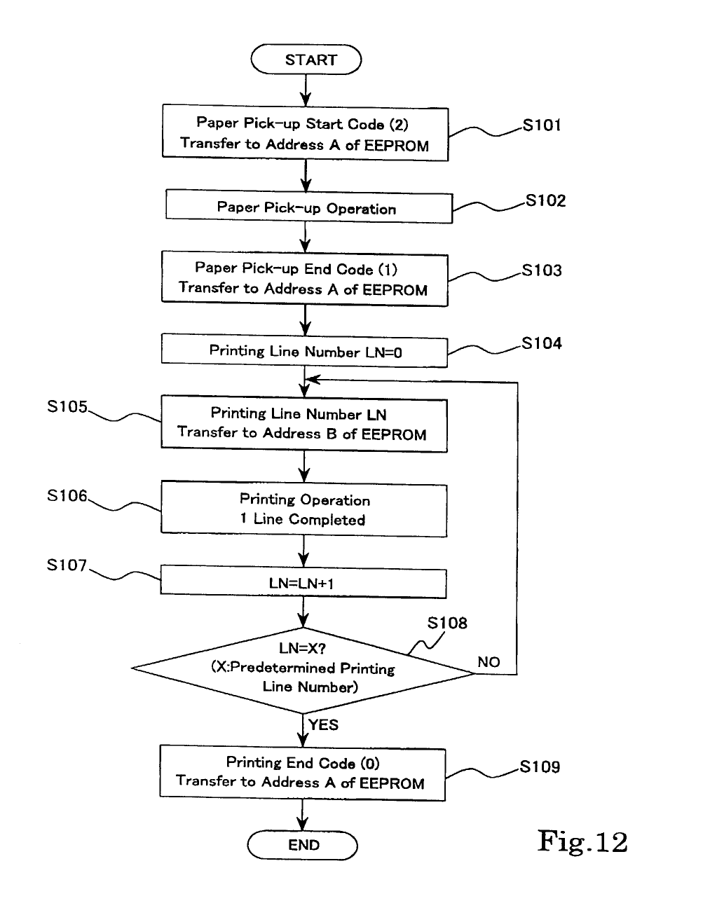

As shown in FIG. 11, when the paper feeding line number LN′ becomes the predetermined paper feeding line number Y, so the printing paper 50 is placed at the predetermined delivery end position, then the printing paper 50 is held under the condition that it is partially protruded from the delivery mouth of the printer 10. The user takes the printing paper 50, and gets it out to remove the printing paper 50 from the printer 10.

Referring again to Step S205, if it is determined that the information is “Paper Pick-up End Code (1)” in Step S205, i.e., if the power was turned off after the pick-up operation of the printing paper 50 has been completed and before the printing operation has been completed or the printing paper 50 has been fed to the predetermined delivery end position, then the printer 10 proceeds to the delivery operation, and reads out the printing line number LN or the paper feeding line number LN′ from Address B in the EEPROM 42 (Step S209). Here, the value read out from Address B in the EEPROM 42 is taken for “Z.”

The printer 10 sets up the value “Z” read out from Address B in the EEPROM 42 to the paper feeding line number LN′ (LN′=Z) (Step S210).

Then, determination is made as to whether the value “Z” read out from Address B in the EEPROM 42 is less than the predetermined paper feeding line number Y (Z<Y) (Step S211).

If it is determined that the value “Z” read out from Address B in the EEPROM 42 is less than the predetermined paper feeding line number Y (Z<Y) in Step S211, i.e., if the printing paper 50 was placed just before the predetermined delivery end position, then the printer 10 proceeds to Step 212, executes the processing mentioned above to deliver the printing paper 50 to the predetermined paper feeding line number, and then waits for a next operation order (Step S217). The printer 10 carries out the next operation after the receipt of the operation order.

On the other hand, if it is determined that the value “Z” read out from Address B in the EEPROM 42 is equal to or more than the predetermined paper feeding line number Y (Z>=Y) in Step S211, i.e., if the printing paper 50 was placed at the predetermined position for delivery end or more, then the printer 10 does not feed the printing paper 50 and proceeds to Step S216. Then, as mentioned above, “Paper Feeding End Code (0)” is transferred to Address A in the EEPROM 42, and it is stored therein (Step S216), and the printer 10 waits for a next operation order (Step S217). The printer 10 carries out the next operation after the receipt of the operation order.

The program as shown in FIG. 13 is executed not only when the power has been turned off during or after the execution of the program as shown in FIG. 12 and then turned on, but also when the power has been turned off during or after the execution of the program as shown in FIG. 13 and then turned on. Appropriate processing (e.g., delivery processing) is executed according to the condition of the printer 10 just before the power has been turned off. Therefore, the printer 10 can operate properly without troubles.

As explained above, according to the printer 10 of the present invention, since the condition of the printer 10 just before the power is turned off (e.g., whether a printing paper 50 is left in the printer 10) is determined, the printer 10 of the present invention can operate properly without trouble. Namely, the printer 10 can complete the operation or processing that the printer 10 executed just before the power has been turned off, and can execute the operation or processing for recovery from abnormal circumstances.

For example, if the power is turned off during the printing or delivery operation, the printer 10 automatically delivers the printing paper 50 left in the printer 10 when the power is turned on. Therefore, the user can easily remove the printing paper 50 from the printer 10. The printer 10 of the present invention can operate properly without trouble.

Further, the printer 10 of the present invention can recognize the condition of the printer 10 just before the power has been turned off without installing many sensors for detecting a printing paper 50. Therefore, since the number of components can be reduced, the labor hour for manufacture (setup of the printer) can be decreased and the time for assembly of the printer can be shortened. Also, the cost for the printer can be cut down.

In the above, the printer according to the present invention has been described in conjunction with the illustrated embodiments, but the present invention is not limited to these cases only, and the configuration of various parts may be replaced with other configurations having similar functions.

For example, in the present invention, if the power has been turned off during printing and then turned on, the printer may be constructed to continue the incomplete printing operation.

If the printer continues to print out the incomplete printing paper, a rewritable nonvolatile memory such as EPROM, EEPROM, and flash memory may be utilized as the memory (storage means) for storing the image data so that the image data is not erased when the power is turned off. For this purpose, the printer may be constructed so that a memory card can be attached to and removed from the printer body. If such a memory card is used for storing the image data, the printer can also continue to print the incompleted printing paper. Examples of such a memory card include a smart medium, a compact flash, a memory stick and the like.

Further, in the present invention, the printer may be constructed so that the user can select either the delivery processing mode mentioned above or the continuous printing mode.

Moreover, in the embodiment, the printer of the present invention records the line number of the delivered printing paper with each line when the printer prints out or delivers a printing paper, but this invention is not limited to this case only. For example, the printer may be constructed to record the line number with each reciprocal motion of the LED head (head for printer) 22.

In case of record with each reciprocal motion, it is preferable that the printer writes data at the upper byte of the EEPROM 42 when the LED head 22 completes moving to the most left side of the main scanning direction (L direction), and writes data at the lower byte of the EEPROM 42 when the LED head 22 completes moving to the most right side of the main scanning direction (R direction). In addition, the order of writing to the upper byte or lower byte may be reverse, namely, the upper byte may be written upon completion of movement to the R direction and the lower byte may be written upon completion of movement to the L direction.

Further, the type of printer of the above-mentioned embodiment is a type of Cycolor, but the present invention is not limited to such a Cycolor printer. Also, the printer of the present invention is not limited to the printers that reproduce (print out) an image on a photosensitive printing paper by exposing the photosensitive printing paper.

Moreover, the printer of the present invention may be one that can reproduce images with a plurality of colors such as a full-color printer, or one that reproduces black-and-white (monochrome) images,

What is claimed is:

1. A printer for printing out a printing paper, comprising:
storage means for storing information on the condition of the printer corresponding to a status of printing operation;
power supply means for supplying power to the printer; and
readout means for reading out the information stored in said storage means when the power to the printer is turned on by said power supply means;
wherein the printer carries out printing operation based on the information read out from said storage means by said readout means when the power to the printer is turned on after the power has been turned off.

2. The printer according to claim 1, wherein said storage means stores information that the printer was on the way to print out a printing paper when the power to the printer was turned off during the printing operation.

3. The printer according to claim 2, wherein the printer is constructed so as to deliver a printing paper if the information read out from said storage means by said readout means indicates that the printer was on the way to print out the printing paper.

4. The printer according to claim 1, further comprising a storage section for putting in printing papers;
wherein said storage means stores any one of information that the printer began to pick up a printing paper from said storage section, information that the printer completed picking up the printing paper, and information that the printer completed printing out the printing paper.

5. The printer according to claim 4, wherein the printer is constructed so as to deliver a printing paper if the information, which is read out from said storage means by said readout means when the power to the printer is turned on, indicates either that the printer began to pick up a printing paper or that the printer completed picking up the printing paper.

6. The printer according to claim 3, wherein said storage means stores information on the condition of the printer corresponding to a status of delivery operation when delivering a printing paper.

7. The printer according to claim 6, wherein the printer is constructed so as to deliver the printing paper if the information read out from said storage means by said readout means indicates that the printer was on the way to deliver the printing paper.

8. The printer according to claim 3, wherein said storage means stores information on the condition of the printer corresponding to the number of fed lines of a printing paper when delivering a printing paper.

9. The printer according to claim 1, wherein said storage means stores information on the number of fed lines of a printing paper when printing out the printing paper.

10. The printer according to claim 1, wherein said storage means includes a rewritable nonvolatile memory.

11. The printer according to claim 1, further comprising a head for exposure on which one or more light sources are provided;
wherein the printing paper is a photosensitive printing paper, and wherein the printer is constructed to reproduce an image on the photosensitive printing paper by exposing the photosensitive printing paper by means of the head for exposure.

12. The printer according to claim 1, further comprising a head for exposure on which one or more light sources for emitting red light, one or more light sources for emitting green light, and one or more light sources for emitting blue light are provided;
wherein the printer is constructed to reproduce an image on a photosensitive printing paper by exposing the photosensitive printing paper by means of the head for exposure.

13. The printer according to claim 12, further comprising:
a first group of registers for setting up image data corresponding to the light sources for emitting red light, the image data corresponding to the light sources for emitting green light, and the image data corresponding to the light sources for emitting blue light; and
a second group of registers for holding the image data, which is set up in said first group of registers;
wherein the printer is constructed so as to set up next image data in said first group of registers and to drive each of the light sources provided on the head for exposure by using the image data that is held in said second group of registers in parallel.

14. The printer according to claim 1, wherein the printer is constructed so as to reproduce an image on a printing paper that contains a plurality of photosensitive microcapsules.

15. The printer according to claim 1, wherein the printer is a Cycolor type printer.
